(19) United States
(12) Patent Application Publication
(10) Pub. No.: US 2012/0312759 A1
(43) Pub. Date: Dec. 13, 2012

(54) System and Method for Pre-Cleaning Fuel

(75) Inventors: Jeffrey R. Ries, Metamora, IL (US); Christopher L. Armstrong, Washington, IL (US); John R. Jones, Creve Coeur, IL (US); Kevin L. Martin, Washburn, IL (US)

(73) Assignee: CATERPILLAR, INC., Peoria, IL (US)

(21) Appl. No.: 13/159,029

(22) Filed: Jun. 13, 2011

(51) Int. Cl. B01D 35/28; B01D 27/06; B01D 37/00

(52) U.S. Cl. 210/806; 210/337; 210/232; 210/172.6

(57) ABSTRACT

A fuel system having a fuel tank and a fuel filter is disclosed. The fuel filter is disposed within the fuel tank and connected to a fuel tank opening, the fuel filter including a filter basket, a perforated tube positioned within the filter basket and a filter cartridge connected to an access cover and extending partially within the perforated tube.

### TECHNICAL FIELD OF THE DISCLOSURE

The present disclosure relates to fuel systems and, more particularly, relates to filtration employed in fuel systems for pre-cleaning fuel.

### BACKGROUND OF THE DISCLOSURE

Fuel system contamination can cause serious problems in any engine. Modern high-performance, low-emissions models are especially vulnerable to contaminants. Generally speaking, fuel contaminants can be described as small to microscopic particles suspended in any fuel and, are typically measured in units called microns. One micron is equivalent to one-millionth of a meter. Various types of contaminants can be found in fuel. For example, dirt and dust can be present, which can cause fungi growth and cloudiness. Rust can accumulate in fuel flowing through rusted hoses and fuel lines corroding components, such as, injectors and control valves of an engine. Excessive water in fuel can cause algae formation while certain extraneous particulates can affect fuel stability.

Such contaminants in fuel are common and can cause premature engine wear, reduce component life, reduce performance and even cause sudden engine failure. As critical components wear prematurely, engine power drops off, fuel consumption rises, emissions increase and the odds of a costly breakdown rise dramatically. In at least some occasions, contaminants can be as abrasive as the materials used to machine parts in the manufacturing process of an engine. Accordingly, alleviating or possibly even completely eliminating contamination from fuel before fuel reaches the engine is highly desirable. These issues may be particularly acute in remote locales where fuel is stored on construction sites to power construction equipment or in nations or regions where fuel quality guidelines are either not stringent or loosely enforced.

While the effects of dirty fuel can be minimized by using proper storage, handling, maintenance and service processes, such methods are often not followed, or even if followed may not be sufficient and may need to be augmented by other procedures. Techniques for minimizing and/or removing contaminants in fuel have been proposed in the past. One technique employs specialized external pumps for pre-cleaning and filtering fuel before fuel enters a fuel tank for combustion and/or storage. Although effective, such pumps nonetheless have several disadvantages. For example, these pumps are typically bulky and need to be hauled from location to location depending upon the disposition of the fuel system needing fuel pre-cleaning. Such pumps may also be unreliable and susceptible to breaking down. Furthermore, pumps occupy space, and are expensive to own, maintain and replace.

Accordingly, it would be advantageous if an improved pre-cleaning filtration system were developed. It would be beneficial if such a system were also reliable, less bulky, transparent to the user, consumed less space, and provided high-efficiency filtration and pre-cleaning at an economical cost.

### SUMMARY OF THE DISCLOSURE

In accordance with one aspect of the present disclosure, a fuel filter is disclosed. The fuel filter may include a filter basket, a first filter component positioned within the filter basket, and a second filter component connected to an access cover and extending partially within the first filter component.

In accordance with another aspect of the present disclosure, a fuel system is disclosed. The fuel system may include a fuel tank having a fuel tank opening and a fuel tank body. The fuel system may additionally include a fuel filter disposed within the fuel tank body and connected to the fuel tank opening. The fuel filter may include a filter basket, a perforated tube positioned within the filter basket and a filter cartridge connected to an access cover and extending partially within the perforated tube.

In accordance with yet another aspect of the present disclosure, a method of pre-cleaning fuel is disclosed. The method may include providing a fuel filter having a filter basket, a perforated tube and a filter cartridge, assembling the fuel filter within a fuel tank about a fuel tank opening, pouring fuel through the fuel tank opening and filtering the fuel poured through the fuel filter.

### BRIEF DESCRIPTION OF THE DRAWINGS

FIG. 1 is a schematic representation of a fuel tank employing a fuel filter, in accordance with at least some aspects of the present disclosure;

FIG. 2 is a cross-sectional view of the fuel filter of FIG. 1;

FIG. 3 is an exploded view showing various components of the fuel filter of FIG. 2;

FIG. 4 is another exploded view showing some of the components of the fuel filter of FIG. 3 in greater detail; and

FIG. 5 is a flowchart showing a method of filtering fuel through the fuel filter of FIG. 1.

While the present disclosure is susceptible to various modifications and alternative constructions, certain illustrative embodiments thereof, will be shown and described below in detail. It should be understood, however, that there is no intention to be limited to the specific embodiments disclosed, but on the contrary, the intention is to cover all modifications, alternative constructions, and equivalents along within the spirit and scope of the present disclosure.

### DETAILED DESCRIPTION OF THE DISCLOSURE

A fuel system having a fuel tank and a fuel filter for filtering and pre-cleaning fuel is disclosed. The fuel filter may include a filter basket and a first filter component (such as a perforated tube). The fuel filter may also include a second filter component (such as a filter cartridge) that may be fitted to a fuel tank access cover and disposed partially within the first filter component. The access cover may cover a fuel tank opening such that any fuel entering the fuel tank through the fuel tank opening passes through the second filter component. While not exclusive, such a fuel system can be effectively employed in various work machines used in the construction, earth moving, and agriculture fields, including but not limited to track-type tractors, excavators, graders, rollers, off-highway trucks, pipe layers and loaders.

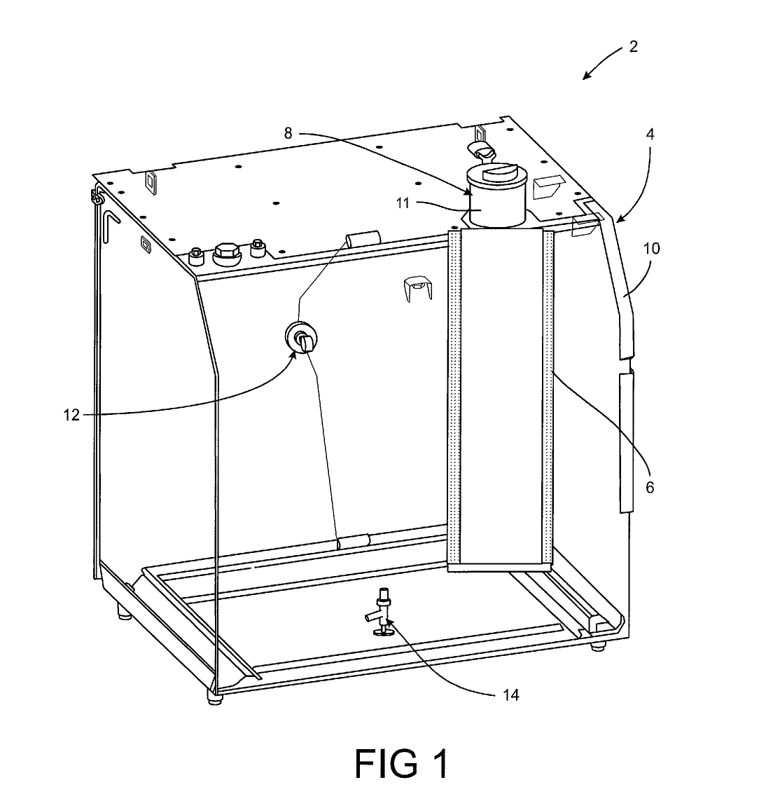

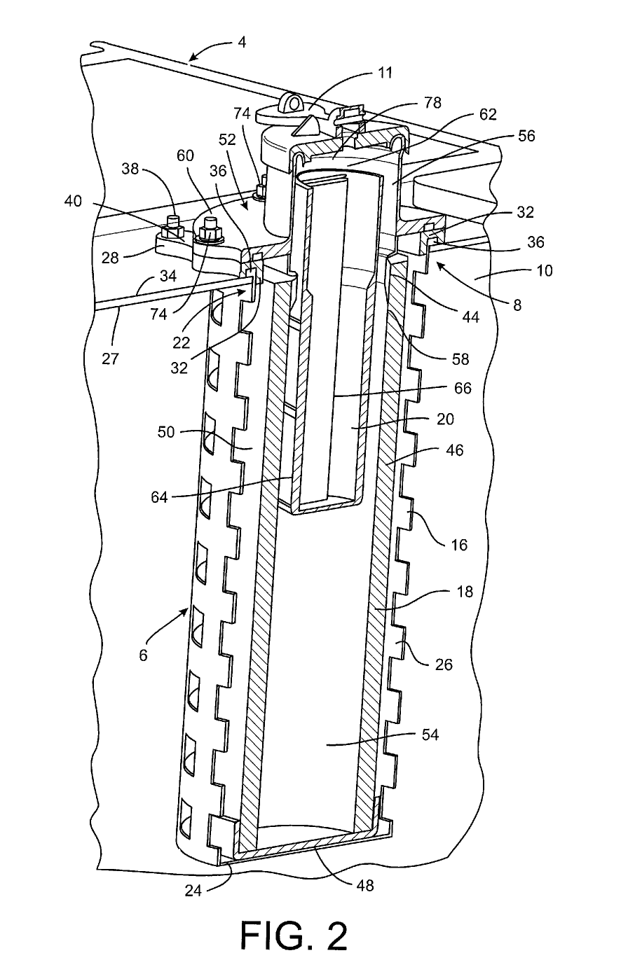

Referring now to FIG. 1, a fuel system 2 is shown, in accordance with at least some embodiments of the present disclosure. As shown, the fuel system 2 may include a fuel tank 4 employing a fuel filter 6 therein for pre-cleaning fuel entering the fuel tank. The fuel filter 6 is described in greater detail below with respect to FIGS. 2-4. While all of the components of the fuel tank 4 have not been shown, a typical fuel tank of the type that may be employed for purposes of the present disclosure may include a fuel tank opening 8 for filling fuel (through a fuel nozzle, not shown) and storing that fuel within a fuel tank body 10. The fuel tank opening 8 may be covered and protected by a fuel tank cap 11. The fuel tank 4 may be a stand-alone truck or may be mounted in or on a work machine (not shown), such as but not limited to those listed above.

The configuration and, particularly, the shape and size of the fuel tank opening 8 and the fuel tank cap 11, as well as the manner of securing the fuel tank cap to the fuel tank opening may vary depending upon several factors, such as, the type of the fuel tank 4, the type of fuel stored within the fuel tank, the shape and size of the nozzle employed for filling fuel through the fuel tank opening, the shape and size of the work machine using the fuel tank, etc. For example, in some embodiments, the fuel tank opening 8 may be provided with external threads on a neck portion thereof, which may be designed to mate and lock with corresponding internal threads on the fuel tank cap 11. In other embodiments, the fuel tank opening 8 may have friction nubs and the fuel tank cap 11 may be frictionally snapped to the fuel tank opening. In alternate embodiments, other commonly employed mechanisms for securing the fuel tank cap 11 to the fuel tank opening 8 may be employed.

In addition to the fuel tank opening 8 and the fuel tank cap 11, the fuel tank 4 and particularly, the fuel tank body 10 of the fuel tank may be equipped with several components, such as, a fuel sensor 12 (shown in two positions) for sensing the level of the fuel within the fuel tank body 10 and a fuel supply 14 for supplying fuel from within the fuel tank 4 to an exterior user (such as an engine or another fuel tank of the work machine) thereof. Several other components, such as, various vents, gauges, hose assemblies, nozzles etc., although not shown and described, are contemplated in combination or conjunction with the fuel tank 4 and considered within the scope of the present disclosure. It will also be understood that portions of the fuel tank body 10 have been shown as transparent merely for explanation purposes. Although the fuel tank body (or portions thereof) 10 may indeed be transparent, this need not and likely is not the case. In at least some embodiments, the fuel tank body 10 (or portions thereof) may be opaque or translucent.

Furthermore, the shape, size and material of the fuel tank 4 may vary depending upon the application of the fuel tank. The fuel tank 4 is representative of a variety of fuel tanks, such as, in-machine fuel tanks, above-ground or under-ground bulk storage stationary fuel tanks employed on construction sites, tanker trucks in aviation, marine and other commercial transportation fleet re-fueling, etc. The fuel tank 4, whether in-machine or bulk storage, may be employed for storing fuels, such as, gasoline, diesel oil, kerosene oil or any other type of liquid fuel that may require filtration and pre-cleaning.

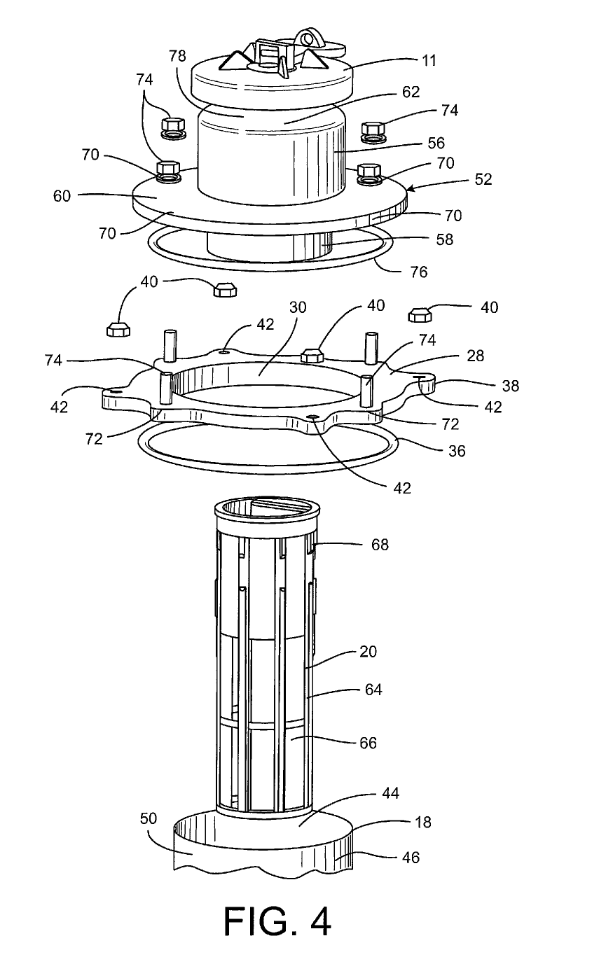

Referring now to FIGS. 2-4, the fuel filter 6 is shown, in accordance with at least some embodiments of the present disclosure. FIG. 2 in particular shows a cross-sectional view of the fuel filter 6, while FIGS. 3 and 4 show exploded views thereof. As shown, the fuel filter 6 may include a filter basket 16, a perforated tube 18 and a filter cartridge 20, each of which is described in greater detail below. The fuel filter 6 may be dispensed within the fuel tank body 10 and connected to the fuel tank opening 8 for filtering and pre-cleaning fuel as fuel is dispensed through the fuel tank opening.

With respect to the filter basket 16, it may be a cylindrical basket having an open top portion 22, a solid floor portion 24 and a mesh patterned body 26. The solid floor portion 24 may rest securely on a bottom surface 25 of the fuel tank 4. The filter basket 16 may be employed for holding the perforated tube 18, protecting the perforated tube and the filter cartridge 20, as well as securing the fuel filter 6 to the fuel tank opening 8. The shape and size of the filter basket 16 may vary depending upon the shape and size of the perforated tube 18, as well as the size of the fuel tank 4 and/or work machine. In addition, the diameter of at least the top portion 22 of the filter basket 16 may vary to correspond to an outer diameter (e.g., substantially similar) of the fuel tank opening 8 proximate an inner surface 27 of the fuel tank body 10. The filter basket 16 may be made of rust resistant material such as, but not limited to plastic, or rust resistant metal.

In order to connect the filter basket 16 to the fuel tank opening 8, the top portion 22 of the filter basket may be inserted (e.g., frictionally) within the fuel tank opening on the inner surface 27 side of the fuel tank body 10 and secured in position by way of an annular flange 28 positioned on an outer surface 34 side of the fuel tank body. As shown more clearly in FIGS. 3 and 4, the annular flange 28 may be designed with a central aperture 30 and a depending portion 32 (See FIG. 2). The central aperture 30 may be sized to have a diameter substantially similar to an outer diameter of the fuel tank opening 8. Accordingly, the flange 28 may be positioned about the fuel tank opening 8 on the outer surface 34 of the fuel tank body 10 such that the depending portion 32 extends into the fuel tank opening and abuts an inner peripheral wall thereof. By virtue of extending and abutting the peripheral wall of the fuel tank opening 8, the depending portion may sandwich the top portion 22 of the filter basket 16 with the peripheral wall of the fuel tank opening.

A seal gasket 36, such as a rubber gasket or an O-ring, may also be employed for providing a tight and leak-proof fit between the flange 28 and the filter basket 16. The seal gasket 36 may be seated between the depending portion 32 and a peripheral portion 38 of the flange 28 on the outer surface 34 of the fuel tank body 10. The flange 28 may then be fastened to the outer surface 34 of the fuel tank body 10 by way of a plurality of nuts and bolts 40 of other fasteners (not all of which are visible) through a set of holes 42 provided along the peripheral portion 38 thereof, thereby securing the filter basket 16 to the fuel tank opening 8.

Notwithstanding the mechanism described above for securing the filter basket 16 to the fuel tank opening 8, it will be understood that in other embodiments, other mechanisms to provide a tight and leak-proof seal between the filter basket and the fuel tank opening may be employed. The seal gasket 40 may be replaced by or used in addition to other sealing mechanisms, while other fastening mechanisms to secure the flange 28 to the outer surface 34 of the fuel tank body 10 may be employed.

Subsequent to securing the filter basket 16 to the fuel tank opening 8, the perforated tube 18 may be positioned within the filter basket. Alternatively, the perforated tube 18 may be positioned within the filter basket 16 before securing the filter basket to the fuel tank opening 8. In any event, similar to the filter basket 16, the perforated tube 18 may be a cylindrical tube and may be dimensioned (e.g., length and diameter) to fit securely within the filter basket. As shown, the perforated tube 18 may include a top opening 44, a perforated body 46 having an outer wall 50 and an inner wall 54, and a bottom cover portion (or end cap) 48. The perforated tube 18 may be inserted and supported within the filter basket 16 by way of the bottom cover portion 48, which may rest on the floor portion 24 of the filter basket. In at least some embodiments, the bottom cover portion 48 may be formed separately from the perforated body 46 and attached (e.g., frictionally or otherwise fastened) thereto, as shown. In other embodiments, the bottom cover portion 48 may be formed integrally with the perforated body 46. Furthermore, although the bottom cover portion 48 has been shown as being solid in FIGS. 2-4, it will be understood that in at least some embodiments, the bottom cover portion may be perforated as well, or may assume other configurations.

The perforated tube 18 in particular may be employed for providing additional filtering of debris and contaminants that remain and pass through the filter cartridge 20. As such, the perforated tube 18 may be constructed of a high efficiency synthetic or cellulosic material and the size of the pores within the perforated body 46 may vary as well depending upon the type and size of the contaminants desired to be filtered. In at least some embodiments, the perforated tube 18 may additionally be employed and constructed to act as a water separator for separating any free-water from the incoming fuel. In other embodiments, a separate water separator may be employed with the fuel filter 6.

Furthermore, in order to prevent any fuel and, particularly, unfiltered fuel from spilling over the top opening 44 and going between the outer wall 50 of the perforated body 46 and the filter basket 16, the top opening may abut, as shown in FIG. 2, a surface of an access cover 52, described below. Specifically, portions of the inner wall 54 proximate the top opening 44 of the perforated tube 18 may abut the access cover 52 to prevent leakage of any unfiltered fuel. The perforated tube 18 may be made of any number of different rust resistant materials including, but not limited to, plastic and rust resistant metal.

In addition to securing the perforated tube 18, the access cover 52 may be employed for securing the filter cartridge 20. Specifically, the filter cartridge 20 may be connected to the access cover 52 and suspended partially within the perforated tube 18, such that any fuel dispensed within the fuel tank opening 8 is actually dispensed through an opening in the access cover and automatically passed through the filter cartridge. Accordingly, and as shown more clearly in FIG. 4, the access cover 52 may include a first longitudinal tubular member 56, a second longitudinal tubular member 58 in line and aligned concentrically with the first tubular member and an annular rim portion 60 extending radially outwardly and separating the first and the second tubular members.

Each of the first and the second tubular members 56 and 58, respectively, may define a bore 62 for receiving and securing the filter cartridge 20, as described in greater detail below. In at least some embodiments, the diameter of the bore 62 may be substantially similar to the diameter of the inner wall 54 of the perforated tube 18 (and/or diameter of the filter cartridge 20) and smaller than the diameter of the fuel tank opening 8. Furthermore, each of the first and the second tubular members 56 and 58, respectively, as well as the rim portion 60 may be formed integrally as a single unit, as shown, or one or more of those components may be formed separately and connected together in operational association to form the access cover 52.

With respect to the filter cartridge 20 in particular, in at least some embodiments and, as shown, it may be a cylindrical, disposable cartridge having a pleated surface 64 and radial beading 66. The pleated surface 64 may provide filtering of the incoming fuel, while the radial beading 66 may serve to maintain stability and spacing of the pleated surface during and after the filtering operation, as well as prevent bunching of the pleats of the pleated surface, thereby maximizing the efficiency, capacity and life of the filter cartridge 20. The filter cartridge 20 may be constructed of a high efficiency cellulosic or synthetic medium to filter and pre-clean dust, debris, and other contaminants from the fuel entering the fuel tank 4. In at least some embodiments, the filter cartridge 20 may be designed to have a micron rating of four (4), although in other embodiments, the rating of the filter cartridge may vary to less than four micron or possibly even greater than four micron depending upon the size of the contaminants desired to be filtered. Furthermore, in some embodiments, the filter cartridge 20 may be over 800 millimeters in length and about 150 millimeters in diameter, while in other embodiments, the length and diameter of the filter cartridge may vary. Of course, these dimensions are simply exemplary and other dimensions are certainly possible and encompassed within the scope of the present disclosure.

The filter cartridge 20 may additionally include frictional nubs 68 (See FIG. 4) to attach and connect the filter cartridge within the access cover 52. Specifically, to connect the filter cartridge 20 to the access cover 52, the filter cartridge may be inserted within the bore 62 of the first and the second tubular members 56 and 58, respectively, and the frictional nubs 68 may engage and lock with corresponding surfaces (not visible) within the bore and, particularly within the first tubular member. Other mechanisms for securing and holding the filter cartridge 20 within the access cover 52 may be employed in other embodiments.

After securing the filter cartridge 20 to the access cover 52, the filter cartridge may be secured to the fuel tank 4 by securing the access cover to the flange 28 about the fuel tank opening 8. Accordingly, the rim portion 60 may be provided with a set of holes 70 that correspond with a set of holes 72 on the peripheral portion 38 of the flange 28 for connecting the access cover to the flange and the fuel tank body 10 about the fuel tank opening 8. In particular, the access cover 52 may be positioned over the flange 28 such that the second tubular member 58 (along with the attached filter cartridge 20) extends through the central aperture 30 of the flange, and the holes 70 of the rim portion align with the holes 72 on the flange. Nuts, bolts or other fasteners 74 may be employed for securing the access cover 52 to the flange 28 through the holes 70 and 72. A gasket 76 may additionally be employed between the access cover 52 and the flange 28 to alleviate frictional surfaces therebetween and to provide a tight, leak-resistant seal.

By virtue of securing the access cover 52 to the fuel tank body 10, the second tubular member 58 may extend within the perforated tube 18 and abut the inner wall 54 of the perforated body 46 to seal the perforated tube against leakage. Furthermore, securing the access cover 52 causes the filter cartridge 20 to be disposed within the perforated tube and extend partially therewithin to filter incoming fuel. Additionally, upon securing the access cover 52 to the flange 28 and the fuel tank opening 8, the access cover completely covers the fuel tank opening 8 and an aperture 78 of the first tubular member 56 becomes the new and actual fuel tank opening such that any fuel poured within the fuel tank 4 is poured through the aperture 78. Moreover, the fuel tank cap 11 can then be secured to the aperture 78 instead of the fuel tank opening 8. In at least some embodiments, the fuel tank cap 11 may be snap fit within the aperture 78, or alternatively, in other embodiments, threads may be provided on the fuel tank cap for mating with internal threads on the aperture 78. In alternate embodiments, other mechanisms for fitting the fuel tank cap 11 to the aperture 78 may be employed, as described above.

### INDUSTRIAL APPLICABILITY

In general, a fuel filter for filtering and pre-cleaning fuel in a fuel system is described above. The fuel filter may include a filter basket for connecting the fuel filter to a fuel tank opening of a fuel tank and for supporting and holding a perforated tube. The fuel filter may also include a filter cartridge that may be fitted to an access cover that covers the fuel tank opening such that any fuel entering the fuel tank through the fuel tank opening passes through the filter cartridge. Various sealing surfaces provided relative to the access cover, the filter basket and the fuel tank ensure that tight and leak-proof filling and filtering of the fuel can be achieved.

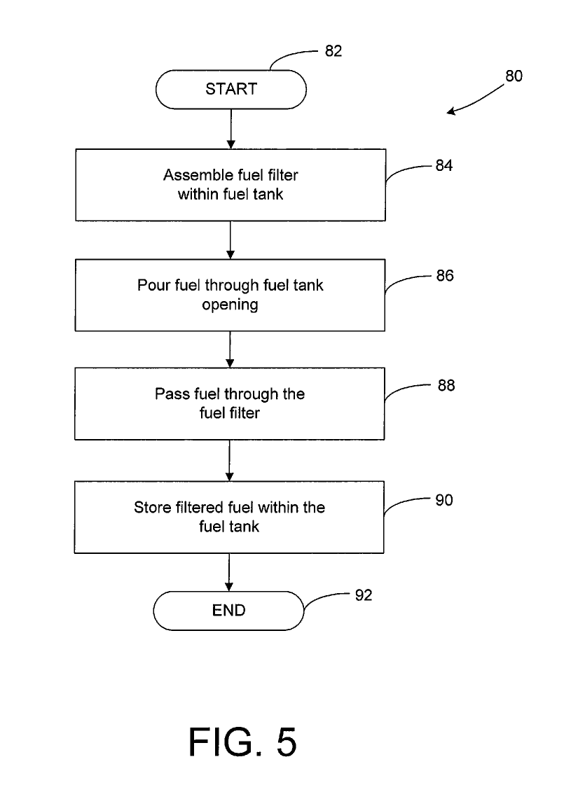

A method 80 of pre-cleaning and filtering fuel entering the fuel tank is shown with respect to FIG. 5. After starting at a step 82, the fuel filter may first be assembled within the fuel tank at a step 84. As described above, the fuel filter may be assembled (or installed) within the fuel tank by securing the filter basket to the fuel tank opening within the fuel tank body, positioning the perforated tube within the filter basket, securing the filter cartridge to the access cover and fastening the access cover about the fuel tank opening such that the filter cartridge is suspended at least partially within the perforated tube. Notwithstanding the order of assembling the fuel filter described above, it will be understood that this order may vary. For example, in some embodiments, the filter cartridge may be secured first to the access cover before securing the filter basket to the fuel tank and/or the perforated tube may be positioned within the filter basket before the filter basket is secured.

Subsequent to assembling the fuel filter within the fuel tank at the step 84, the fuel desired to be stored within the fuel tank is poured through the fuel tank opening at a step 86. As described above, after assembling the fuel filter within the fuel tank, an opening of the access cover becomes the actual opening of the fuel tank and fuel is poured into the fuel tank through this actual opening. Next, at a step 88, the poured fuel is passed through the filter cartridge and any dust, debris or other contaminants are filtered to obtain a first clean fuel. The first clean fuel is then passed through the perforated tube and any additional contaminants that were not filtered through the filter cartridge are filtered by the perforated tube to obtain a second clean fuel. This second fuel then passes through the filter basket into the fuel tank body for storage at a step 90. Any dust, debris or other contaminants that are filtered by the perforated tube may collect along the bottom cover portion of the perforated tube, which may be periodically removed from the fuel tank for cleaning and/or replacement. Similarly, the filter cartridge may be replaced and/or cleaned periodically to maintain the efficiency of the fuel filter.

It will be understood that although the steps 86 and 88 of pouring fuel and passing fuel through the filter cartridge and perforated tube, respectively, have been described above as happening one after another, there may not necessarily be a time lag between those steps. Rather, those steps may happen simultaneously such that the fuel may be continuously poured though the fuel tank opening and filtered through the filter cartridge and the perforated tube. After all of the required quantity of fuel has been poured into the fuel tank, or after filling the fuel tank to its maximum capacity, the process ends at a step 92.

Thus, by virtue of providing the fuel filter and connecting the fuel filter to the fuel tank opening itself, any incoming fuel may be pre-cleaned and pre-filtered before storing and/or supplying that fuel for combustion in an internal combustion engine of a work machine or the like. Positioning the fuel filter at the fuel tank opening also provides an additional advantage insofar as the fuel filter is invisible to a customer when filling the fuel tank, consumes less space compared to conventional fuel filters, automatically performs filtering without the requirement of any pumps or other special equipment, is simple to maintain and economical to use.

Accordingly, the present disclosure provides a high efficiency, durable and inexpensive filtering mechanism for filtering and pre-cleaning fuel to alleviate (or possibly even completely eliminate) contaminants from the fuel, thereby improving fuel stability as well as increasing the performance and reliability of engines employing the filtered fuel.

While only certain embodiments have been set forth, alternatives and modifications will be apparent from the above description to those skilled in the art. These and other alternatives are considered equivalents and within the spirit and scope of this disclosure and the appended claims.

What is claimed is:

1. A fuel filter, comprising:
a filter basket;
a first filter component positioned within the filter basket; and
a second filter component connected to a fuel tank access cover and extending partially within the first filter component.

2. The fuel filter of claim 1, wherein the filter basket includes a cylindrical mesh patterned body, a floor portion and a top portion for connecting the fuel filter within a fuel tank.

3. The fuel filter of claim 2, further comprising a flange having a central aperture and a depending portion for securing the top portion of the filter basket to a fuel tank opening of the fuel tank.

4. The fuel filter of claim 1, wherein the first filter component is a perforated tube having a perforated body, a top opening and a bottom cover portion resting on a floor portion of the filter basket.

5. The fuel filter of claim 1, wherein the second filter component is a filter cartridge having a pleated surface.

6. The fuel filter of claim 5, wherein the filter cartridge is at least 800 millimeters long.

7. The fuel filter of claim 5, wherein the filter cartridge has a rating of 4 micron.

8. The fuel filter of claim 5, wherein the filter cartridge has a diameter of about 150 millimeters.

9. The fuel filter of claim 1, wherein the access cover comprises (a) first and second tubular members defining a central bore therein for receiving the second filter component, and (b) a rim portion extending radially outwardly from the first and the second tubular members for seating about an outer periphery of a fuel tank opening.

10. The fuel filter of claim 9, wherein the central bore further comprises an aperture for receiving a fuel tank cap.

11. A fuel system, comprising:
a fuel tank having a fuel tank opening and a fuel tank body; and
a fuel filter disposed within the fuel tank body and connected to the fuel tank opening, the fuel filter having a filter basket, a perforated tube positioned within the filter basket and a filter cartridge connected to an access cover and extending partially within the perforated tube.

12. The fuel system of claim 11, further comprising a flange having a central aperture and a depending portion, the central aperture being positioned about the fuel tank opening on an outer surface of the fuel tank body and the depending portion extending within the fuel tank opening to sandwich the filter basket between the depending portion and a wall of the fuel tank opening within the fuel tank body.

13. The fuel system of claim 12, wherein the access cover has first and second tubular members defining a central bore therein, the first and the second tubular members extending through the central aperture of the flange, the second tubular member abutting the perforated tube.

14. The fuel system of claim 13, wherein the access cover substantially completely covers the fuel tank opening and the first tubular member comprises an aperture for receiving fuel into the fuel tank.

15. The fuel system of claim 11, wherein the filter cartridge is at least 800 millimeters long, has a diameter of about 150 millimeters and a micron rating of 4 micron.

16. A method of pre-cleaning fuel, the method comprising:
providing a fuel filter having a filter basket, a perforated tube and a filter cartridge;
assembling the fuel filter within a fuel tank about a fuel tank opening;
pouring fuel through the fuel tank opening; and
filtering the fuel poured through the fuel filter.

17. The method of claim 16, further comprising storing filtered fuel into the fuel tank.

18. The method of claim 16, wherein filtering the fuel poured through the fuel filter further comprises:
passing the poured fuel through the filter cartridge to obtain a first clean fuel; and
passing the first clean fuel through the perforated tube and the filter basket to obtain a second clean fuel.

19. The method of claim 16, wherein assembling the fuel filter within the fuel tank comprises:
securing the filter basket about an inner surface of the fuel tank opening within a fuel tank body;
positioning the perforated tube within the filter basket;
securing the filter cartridge to an access cover; and
securing the access cover about an outer surface of the fuel tank opening.

20. The method of claim 19, wherein pouring fuel through the fuel tank opening comprises pouring fuel through an aperture of the access cover.
